(19) United States
(12) Patent Application Publication
(10) Pub. No.: US 2006/0138295 A1
(43) Pub. Date: Jun. 29, 2006

(54) Apparatus and method for mounting a fixture

(76) Inventor: Frank Blateri, Coppell, TX (US)

Correspondence Address: HAYNES AND BOONE, LLP, 901 MAIN STREET, SUITE 3100, DALLAS, TX, 75202, US

(21) Appl. No.: 11/023,242

(22) Filed: Dec. 27, 2004

(51) Int. Cl. B42F 13/00

(52) U.S. Cl. 248/343

(57) ABSTRACT

An apparatus and method for mounting a fixture having a counterbore to a downrod having a diameter different from that of the counterbore, according to which an adapter is provided that has a counterbore with a diameter that corresponds to the outer diameter of the downrod, and an outer diameter that corresponds to the diameter of the counterbore of the fixture. The end portion of the downrod is connected in the counterbore of the adapter, and a cylindrical portion of the adapter is connected in the counterbore of the fixture.

### BACKGROUND

This invention relates to an apparatus for mounting a fixture to a ceiling.

Fixtures, such as ceiling fans, lights, etc. are often connected to the ceiling by a downrod that extends from the ceiling and is connected between an electrical box, or the like, at the ceiling and a coupling on the fixture, so that the distance from the fixture to the ceiling can be varied by simply varying the length of the downrod.

However, the diameters of the couplings vary and are often not compatible with the diameters of the downrods. Also, the coupling may be configured for a threaded engagement while the downrod is not, or vice versa. According to the present invention, an apparatus is provided to enable a downrod to be connected to a coupling despite the above incompatibilities.

### BRIEF DESCRIPTION OF THE DRAWINGS

FIG. 1 is an exploded, partial sectional/partial elevational view of an embodiment of the present invention.

FIG. 2 is an elevational view depicting the components of FIG. 1 in an assembled condition.

FIG. 3 is an exploded, partial sectional/partial elevational view of an alternate embodiment of the present invention.

FIG. 4 is an elevational view of the embodiment of FIG. 3, depicting the components of FIG. 3 in an assembled condition.

FIG. 5 is an exploded, partial sectional/partial elevational view of an alternate embodiment of the present invention.

FIG. 6 is an elevational view of the embodiment of FIG. 5, depicting the components of FIG. 5 in an assembled condition.

FIG. 7 is an exploded, partial sectional/partial elevational view of an alternate embodiment of the present invention.

FIG. 8 is an elevational view of the embodiment of FIG. 7, depicting the components of FIG. 7 in an assembled condition.

FIG. 9 is an exploded, partial sectional/partial elevational view of an alternate embodiment of the present invention.

FIG. 10 is an elevational view of the embodiment of FIG. 9, depicting the components of FIG. 9 in an assembled condition.

FIG. 11 is an exploded, partial sectional/partial elevational view of an alternate embodiment of the present invention.

FIG. 12 is an elevational view of the embodiment of FIG. 11, depicting the components of FIG. 11 in an assembled condition.

### DETAILED DESCRIPTION

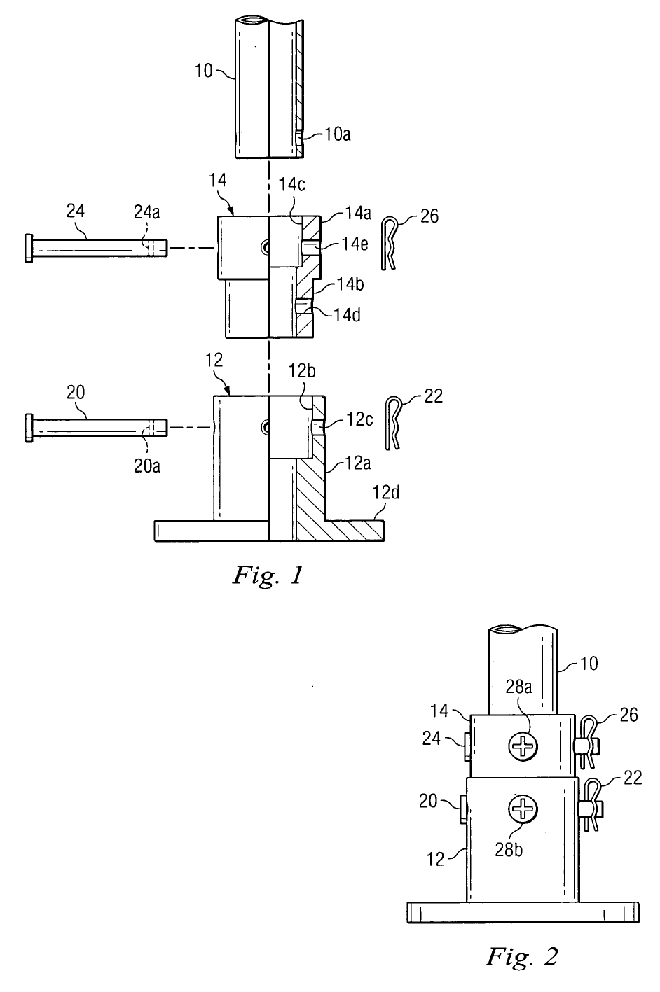

Referring to FIG. 1 of the drawings, the reference 10 refers, in general, to a downrod that is to be connected to a coupling 12. Although not shown in the drawings, it is understood that the upper end of the downrod, as viewed in FIG. 1, is adapted for connection to an electrical box, or the like, mounted in a ceiling (not shown). The downrod 10 is tubular and has two aligned, transverse openings extending through its opposing walls, one of which is shown by the reference numeral 10a.

The coupling 12 is adapted to extend from the upper surface of a fixture, such as a conventional ceiling fan, that extends below the coupling. For example, the coupling could be bolted to the surface, formed integrally with the surface, or attached in any other conventional manner. The coupling 12 is formed by a tubular member 12a, having a counterbore 12b formed in its upper end portion, and two aligned, transverse openings extending through its opposed walls, with one of the openings being shown by the reference numeral 12c. An annular flange 12d extends from the lower end of the member 12a and is adapted to be connected to the above motor housing in any conventional manner such as by bolts, or the like, (not shown) that extend in aligned bores (not shown) in the flange and in the housing.

The diameter of the counterbore 12b of the coupling 12 is designed to receive a downrod having a diameter greater that the outer diameter of the downrod 10. Therefore an adapter 14 is provided to enable the downrod 10 to be securely mounted to the coupling 12. To this end, the adapter 14 is in the form of a tubular member and has a stepped outer diameter to form two cylindrical portions 14a and 14b. The outer diameter of the cylindrical portion 14a is greater than the outer diameter of the cylindrical portion 14b, and a counterbore 14c is formed in the cylindrical portion 14a that extends from its upper end. A transverse bore, or through opening, 14d extends through the cylindrical portion 14b, and two aligned, transverse openings extend through the opposed walls of the cylindrical portion 14a, with one of the openings being shown by the reference numeral 14e.

The outer diameter of the cylindrical portion 14b corresponds to the diameter of the counterbore 12b of the coupling 12 so that the cylindrical portion 14b fits within the counterbore 12b with minimum clearance. When the cylindrical portion 14b is inserted in the counterbore 12b as shown in FIG. 2, the shoulder formed by the stepped outer diameters of the cylindrical portions 14a and 14b rests on the upper end of the cylindrical member 12a.

After the cylindrical portion 14b is inserted in the counterbore 12b, the adapter 14 is rotated relative to the coupling 12, or vice versa, until the bore 14d aligns with the openings 12c. A bolt 20 is then inserted through the aligned bore 14d and openings 12c to lock the adapter 14 to the coupling 12, and a lock pin 22 is inserted through a transverse opening 20a formed in the bolt to retain the bolt in the locking position, as shown in FIG. 2.

The diameter of the counterbore 14c of the adapter 14 corresponds to the outer diameter of the downrod so that the lower end portion of the downrod can be inserted in the counterbore 14c with minimum clearance. After this insertion, the adapter 14 is rotated relative to the downrod 10 until the openings 14e align with the openings 10a. A bolt 24 is then inserted in the aligned openings 14e and 10a to lock the downrod 10 to the coupling 12, and a lock pin 26 is inserted through a transverse opening 24a formed in the bolt to retain the bolt in the locking position.

Thus, the adapter 14 accommodates the difference in diameters of the downrod 10 and the counterbore 12b of the coupling 12.

To insure the stability of the above connection of the downrod 10 to the coupling 12, a set screw 28a can be provided that extends perpendicular to the bolt 24 and through an opening in the adapter 14 and engages the downrod; and a set screw 28b can be provided that extends perpendicular to the bolt 22 and through an opening in the coupling 12 and engages the adapter.

Since the coupling 12 and the adapter 14 are both tubular, electrical wires can be run through their respective bores to enable the aforementioned fixture and electrical box to be electrically connected.

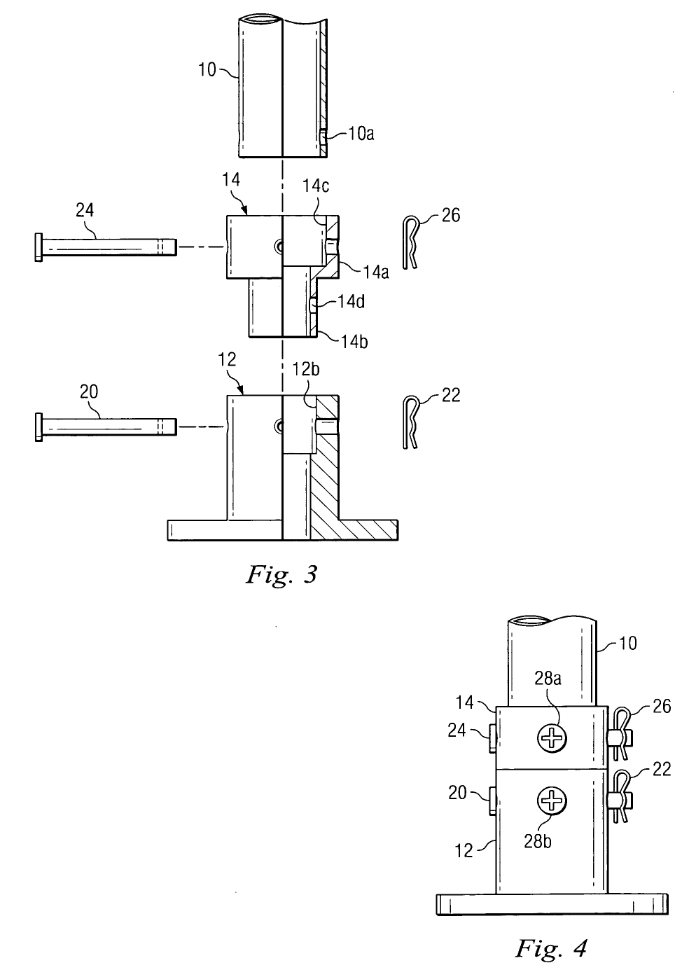

The embodiment of FIGS. 3 and 4 is similar to that of FIGS. 1 and 2, and identical components are given the same reference numerals. The embodiment of FIGS. 3 and 4 is designed to accommodate a downrod 10 that has a diameter greater than the diameter of the counterbore 12b of the coupling 12.

In particular, the counterbore 14c of the adapter 14 corresponds to the diameter of the downrod 10 so that the counterbore 14c receives the relatively large-diameter downrod 10 with minimum clearance. Similarly, the outer diameter of the cylindrical portion 14b of the adapter corresponds to the diameter of the counterbore 12b of the coupling 12 so that the outer diameter of the cylindrical portion 14b of the adapter 14 extends in the relatively small-diameter counterbore 12b of the coupling 12, with minimum clearance. Otherwise the embodiment of FIGS. 3 and 4 is identical to that of FIGS. 1 and 2. Thus, the bolts 20 and 24 and their corresponding lock pins 22 and 26, respectively, as well as the set screws 28a and 28b, can be used in the embodiment of FIGS. 3 and 4 to provide further connections between the adapter 14 and the downrod 10 and between the adapter and the coupling 12.

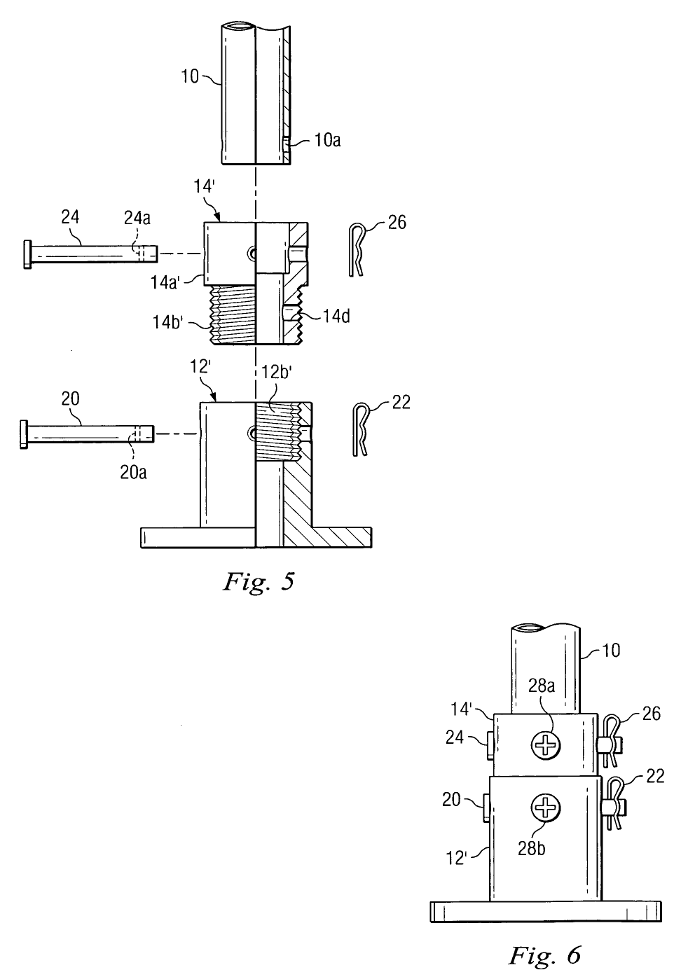

The embodiment of FIGS. 5 and 6 is similar to that of FIGS. 1 and 2, and identical components are given the same reference numerals. The embodiment of FIGS. 5 and 6 is designed to accommodate a tubular coupling 12′ that is similar to the coupling 12 of the previous embodiments, but has a threaded counterbore 12b′ that has a diameter greater than that of the downrod 10′. To this end, a tubular adapter 14′ is provided that is similar to the adapter 14 of the embodiment of FIGS. 1 and 2, with the exception that the adapter 14′ has an externally threaded cylindrical portion 14b′ so as to mate with the internally threaded inner wall forming the counterbore 12b′ of the coupling 12′.

Thus, the adapter 14′ accommodates the difference in diameters of the downrod 10 and the counterbore 12b′ of the coupling 12′ as described above in connection with the embodiment of FIGS. 1 and 2, while also accommodating the threaded counterbore 12b′ and the unthreaded downrod 10.

The embodiment of FIGS. 5 and 6 is otherwise identical to that of FIGS. 1 and 2. Thus, the bolts 20 and 24 and their corresponding lock pins 22 and 26, respectively, as well as the set screws 28a and 28b, can be used in the embodiment of FIGS. 3 and 4 to provide further connections between the adapter 14′ and downrod 10′ and between the adapter 14′ and the coupling 12′.

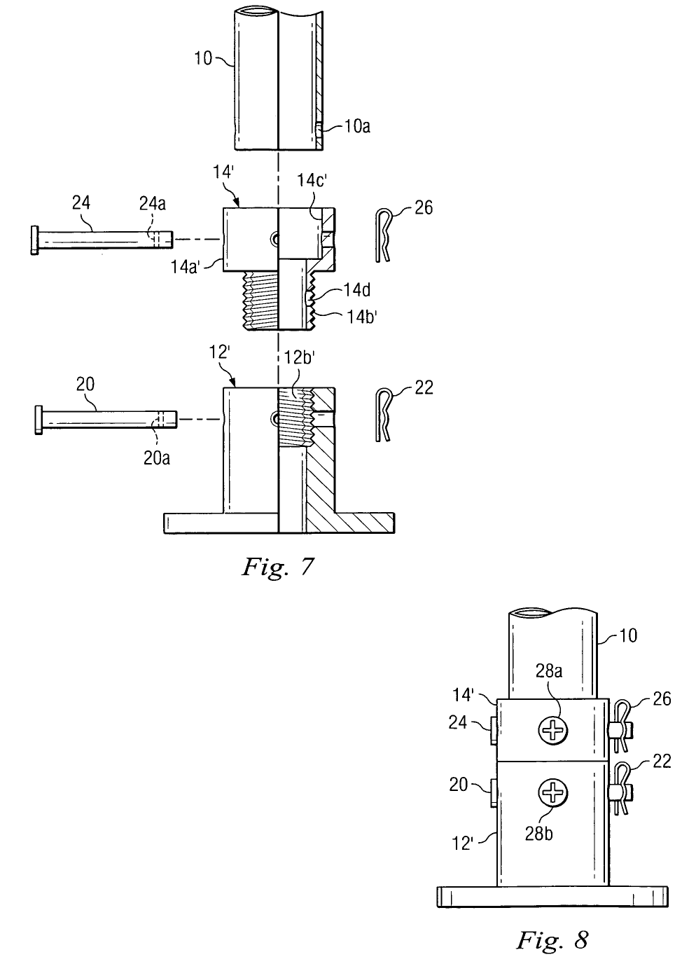

The embodiment of FIGS. 7 and 8 is similar to that of FIGS. 5 and 6, and identical components are given the same reference numerals. The embodiment of FIGS. 7 and 8 is designed to accommodate a tubular coupling 12′ that is similar to the coupling 12 of the previous embodiments, but has a threaded counterbore 12b′ that is less than the diameter of the downrod 10. In this case, the tubular adapter 14′ has a counterbore 14c′ the diameter of which corresponds to the relatively large-diameter downrod 10, so as to receive the end portion of the downrod with minimum clearance. Also, and the outer diameter of the cylindrical portion 14b′ of the adapter 14′ corresponds to the diameter of the relatively small-diameter counterbore 12b′ of the coupling 12b, that is the adapter portion 14b′ extends, in threaded engagement, in the relatively small-diameter counterbore 12b′ of the coupling 12′. Otherwise the embodiment of FIGS. 7 and 8 is identical to that of FIGS. 5 and 6. Thus, the bolts 20 and 24 and their corresponding lock pins 22 and 26, respectively, as well as the set screws 28a and 28b, can be used in the embodiment of FIGS. 7 and 8 to provide further connections between the adapter 14′ and the downrod 10 and between the adapter 14′ and the coupling 12′.

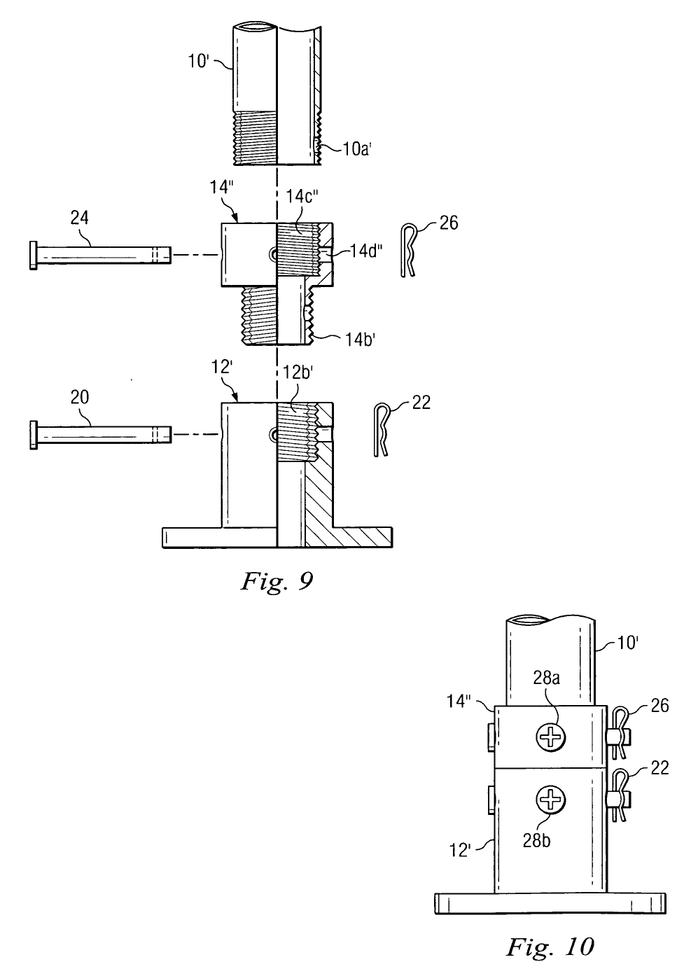

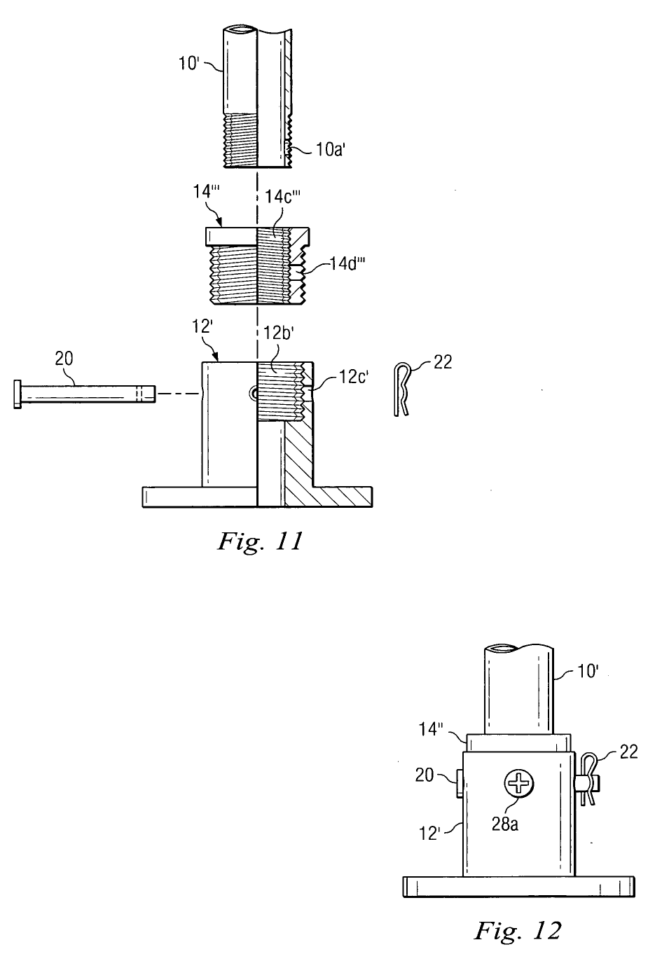

The embodiment of FIGS. 9 and 10 is similar to that of FIGS. 7 and 8 and identical components are given the same reference numerals. The embodiment of FIGS. 9 and 10 is designed to accommodate a downrod 10′ that has an externally threaded end portion and a diameter that is greater than the diameter of the counterbore 12b′ of the coupling 12′. Thus, a tubular adapter 14″ is provided that is similar to the adapter 14′ of the embodiment of FIGS. 7 and 8, but is provided with an internally threaded counterbore 14c″. Otherwise the embodiment of FIGS. 9 and 10 is identical to that of FIGS. 7 and 8. Thus, the diameter of the counterbore 14c″ corresponds to the latter end portion of the downrod 10′, and the outer diameter of the cylindrical portion 14b″ of the adapter 14″ corresponds to the relatively small-diameter counterbore 12b′ of the coupling 12′. Thus, the diameter of the counterbore 14c″ receives the latter end portion of the downrod 10′ with minimal clearance, and the outer diameter of the cylindrical portion 14b″ of the adapter 14″ extends in the relatively small-diameter counterbore 12b′ of the coupling 12′ with minimal clearance. Also, the bolts 20 and 24 and their corresponding lock pins 22 and 26, respectively, as well as the set screws 28a and 28b, are also used in the embodiment of FIGS. 11 and 12 to provide a further connection between the adapter 14″ and the downrod 10′ and a further connection between the adapter 14″ and the coupling 12′.

The embodiment of FIGS. 11 and 12 is designed to connect the downrod 10′ of the embodiment of FIGS. 9 and to the coupling 12 utilizing only one bolt. In this embodiment the diameter of the downrod 10′ is less that that of the counterbore 12b′ of the coupling 12′. As in the embodiment of FIGS. 9 and 10, the downrod 10′ has two aligned, transverse openings extending through its opposed walls, one of which is shown by the reference numeral 10a′; and the coupling 12′ has a transverse bore, or through opening, 12c′.

A tubular adapter 14′″ is provided that has a stepped outer diameter to form two cylindrical portions 14a′″ and 14b′″. The outer diameter of the cylindrical portion 14a′″ is greater than the outer diameter of the cylindrical portion 14b′″, and an internally threaded through bore 14c′″ extends through the adapter 14′″ that corresponds to the externally threaded lower end portion of the downrod 10′. Thus, latter lower end portion of the downrod 10′ threadedly engages the bore 14c′″.

The outer surface of the adapter 14′″ is externally threaded and sized to correspond to the relatively large-diameter, internally threaded, counterbore 12b′ of the coupling 12′, that is the latter outer surface threadedly engages the counterbore 12b′. In this context a shoulder is formed between the two cylindrical portions 14a′″ and 14b′″of the adapter 14′″ that engages the corresponding end of the coupling 12′ in the engaged position shown in FIG. 12. The coupling 14′″ also has two aligned, transverse openings extending through its opposed walls, one of which is shown by the reference numeral 14d′″.

To assemble the downrod 10′ to the coupling 12′, the adapter 14′″ is threadedly engaged between the downrod and the coupling, as shown in FIG. 12. The design is such that the openings 10a′, 14d′″, and 12c′ can be aligned and the bolt 20 of the previous embodiments can be inserted through the aligned openings, after which the lock pin 22 is inserted through the bolt, to further secure the downrod 10′ to the coupling 12′. Also, the set screw 28a of the previous embodiments can be inserted through aligned, threaded openings in the coupling 12′, the adapter 14′″, and the downrod 10′ in the same manner as discussed above.

### Variations

It is understood that several variations may be made in the foregoing without departing from the scope of the invention. For example, the couplings in each of the above embodiments can be formed integrally with the fixture, or motor housing, or connected to the housing in any conventional manner. Also, the locking bolt 20 can be eliminated in the embodiments of FIGS. 5-12, and the locking bolt 24 can be eliminated in the embodiments of FIGS. 9-12. Further, the embodiments of FIGS. 5-12 are not limited to the diameter of the downrod and the coupling counterbore being different but is equally applicable when these diameters are the same. Moreover, the setscrews 28a and 28b can be eliminated from any of the embodiments.

Although only a few exemplary embodiments have been described in detail above, those skilled in the art will readily appreciate that many other variations and modifications are possible in the exemplary embodiment without materially departing from the novel teachings and advantages of this invention. Accordingly, all such variations and modifications are intended to be included within the scope of this invention as defined in the following claims. In the claims, means-plus-function clauses are intended to cover the structures described herein as performing the recited function and not only structural equivalents, but also equivalent structures.

What is claimed is:

1. Apparatus for mounting a fixture, the apparatus comprising:
a downrod having an outer diameter;
a coupling extending from the fixture and having a counterbore with a diameter that is different from the outer diameter of the downrod; and
a cylindrical adapter having a counterbore with a diameter that corresponds to the outer diameter of the downrod, and a portion having an outer diameter that corresponds to the diameter of the coupling counterbore;
the adapter receiving the end portion of the downrod and the adapter portion extending in the coupling counterbore to connect the downrod to the fixture.

2. The apparatus of claim 1 wherein the downrod has a threaded end portion and the adapter has an internally threaded counterbore so as to receive the end portion in a threaded engagement.

3. The apparatus of claim 1 wherein the coupling counterbore is internally threaded and wherein the adapter is externally threaded so as to extend in the latter counterbore in a threaded engagement.

4. The apparatus of claims 1, 2, or 3, wherein the downrod and the adapter have openings that are aligned when the downrod end portion extends in the adapter counterbore, and further comprising a bolt that extends through the aligned openings to lock the adapter to the downrod.

5. The apparatus of claim 4 further comprising a set screw that extends through an opening in the adapter and engages the downrod.

6. The apparatus of claims 1, 2, or 3 wherein the adapter and the coupling have openings that are aligned when the downrod end portion extends in the adapter counterbore, and further comprising a bolt that extends through the aligned openings to lock the adapter to the coupling.

7. The apparatus of claim 6 further comprising a set screw that extends through an opening in the coupling and engages the adapter.

8. The apparatus of claim 2 wherein the coupling counterbore is internally threaded and wherein the adapter is externally threaded so as to extend in the latter counterbore in a threaded engagement.

9. The apparatus of claim 1 wherein the downrod extends from the ceiling and the coupling is formed integrally with, or is adapted to be connected to, the fixture.

10. The apparatus of claim 1 wherein the fixture is a ceiling fan.

11. An adapter for mounting a downrod to a fixture having a counterbore with a diameter that is different from the outer diameter of the downrod; the adapter comprising a body member having a counterbore with a diameter that corresponds to the outer diameter of the downrod, and an outer diameter that corresponds to the diameter of the fixture counterbore; the adapter receiving the end portion of the downrod, and extending in the fixture counterbore, to connect the downrod to the fixture.

12. The adapter of claim 11 wherein the downrod has a threaded end portion and the adapter has an internally threaded counterbore so as to receive the end portion in a threaded engagement.

13. The adapter of claim 11 wherein the fixture counterbore is internally threaded and wherein the adapter is externally threaded so as to extend in the latter counterbore in a threaded engagement.

14. The adapter of claims 11, 12, or 13, wherein the downrod and the adapter have openings that are aligned when the downrod end portion extends in the adapter counterbore, and further comprising a bolt that extends through the aligned openings to lock the adapter to the downrod.

15. The adapter of claim 14 further comprising a set screw that extends through an opening in the adapter and engages the downrod.

16. The adapter of claims 11, 12, or 13 wherein the adapter and the fixture have openings that are aligned when the downrod end portion extends in the adapter counterbore, and further comprising a bolt that extends through the aligned openings to lock the adapter to the coupling.

17. The adapter of claim 16 further comprising a set screw that extends through an opening in the fixture and engages the adapter.

18. The adapter of claim 11 wherein the fixture counterbore is internally threaded and wherein the adapter is externally threaded so as to extend in the latter counterbore in a threaded engagement.

19. The adapter of claim 11 wherein the downrod extends from the ceiling and wherein the fixture counterbore is formed in a coupling formed integrally with, or is adapted to be connected to, the fixture.

20. The adapter of claim 11 wherein the fixture is a ceiling fan.

21. A method for mounting a fixture having a counterbore to a downrod having a diameter different from that of the counterbore, the method comprising
providing an adapter having a counterbore with a diameter that corresponds to the outer diameter of the downrod, and a portion having an outer diameter that corresponds to the diameter of the fixture counterbore; connecting an end portion of the downrod in the counterbore of the adapter, and connecting a cylindrical portion of the adapter in the fixture counterbore.

22. The method of claim 21 wherein the first-mentioned connection is a threaded connection.

23. The method of claim 21 wherein the second-mentioned connection is a threaded connection.

24. The method of claims 21, 22, or 23, further comprising extending a bolt through aligned openings in the downrod and the adapter to lock the adapter to the downrod.

25. The method of claim 24 further comprising extending a set screw through an opening in the adapter and in engagement with the downrod.

26. The method of claims 21, 22, or 23 further comprising extending a bolt through aligned openings in the adapter and the fixture to lock the adapter to the fixture.

27. The method of claim 26 further comprising extending a set screw through an opening in the fixture and in engagement with the adapter.

28. The method of claim 21 wherein the fixture counterbore is internally threaded and wherein the adapter is externally threaded so as to extend in the latter counterbore in a threaded engagement.

29. The method of claim 21 wherein the downrod extends from the fixture and further comprising the step of connecting a coupling to the fixture, the fixture counterbore being formed in the coupling.

30. The method of claim 21 wherein the fixture is a ceiling fan.
